(19) United States
(12) Patent Application Publication
(10) Pub. No.: US 2017/0015206 A1
(43) Pub. Date: Jan. 19, 2017

(54) Method and System of Making Available Vehicle Functions in Combination with an Inductive Charging System

(71) Applicant: Bayerische Motoren Werke Aktiengesellschaft, Muenchen (DE)

(72) Inventor: Torsten HERZOG, Muenchen (DE)

(21) Appl. No.: 15/281,200

(22) Filed: Sep. 30, 2016

Related U.S. Application Data
(63) Continuation of application No. PCT/EP2015/051651, filed on Jan. 28, 2015.

(30) Foreign Application Priority Data
Apr. 3, 2014 (DE) 10 2014 206 379.5

(51) Int. Cl. B60L 11/18; H02J 7/02

(52) U.S. Cl. CPC B60L 11/182; B60L 11/1846; H02J 7/025

(57) ABSTRACT

A method and a corresponding device are provided for making available one or more vehicle functions, in particular a keyless access function to a vehicle, through interaction with a charging system. A control unit is provided for a charging system for transmitting electrical energy to a vehicle. The charging system has one or more coils by which an electromagnetic charging field is generated. The control unit is configured to detect whether a transmitter unit emits or will emit a signal which is disrupted by the charging field. The control unit is configured to bring about an interruption of the electromagnetic charging field if it has been detected that the transmitter unit emits or will emit the signal.

### CROSS REFERENCE TO RELATED APPLICATIONS

This application is a continuation of PCT International Application No. PCT/EP2015/051651, filed Jan. 28, 2015, which claims priority under 35 U.S.C. §119 from German Patent Application No. 10 2014 206 379.5, filed Apr. 3, 2014, the entire disclosures of which are herein expressly incorporated by reference.

### BACKGROUND AND SUMMARY OF THE INVENTION

The invention relates to a method and to a corresponding apparatus for providing one or more vehicle functions, in particular a keyless access function to a vehicle, through interaction with a cable-free charging apparatus for electric vehicles, for example with an inductive charging system.

Vehicles with an electric drive typically have a battery in which electrical energy for operating an electrical machine of the vehicle can be stored. The battery of the vehicle can be charged with electrical energy from an electrical power supply system. For this purpose, the battery is coupled to the electrical power supply system in order to transmit the electrical energy from the electrical power supply system to the battery of the vehicle. The coupling can be implemented using wires (by means of a charging cable) and/or in a wireless manner (using an inductive coupling between a charging station and the vehicle).

One approach for automatic, cable-free, inductive charging of the battery of the vehicle involves transmitting the electric energy to the battery from the floor to the underbody of the vehicle by way of magnetic induction across the underbody ground clearance 120. This is illustrated, by way of example, in FIG. 1. In particular, FIG. 1 shows a vehicle 100 with a storage unit 103 for electrical energy (for example with a chargeable battery 103). The vehicle 100 has what is referred to as a secondary coil in the underbody of the vehicle, wherein the secondary coil is connected to the storage unit 103 by an impedance matching arrangement, not shown, and a rectifier 101. The secondary coil is typically part of what is referred to as a “wireless power transfer” (WPT) vehicle unit 102.

The secondary coil of the WPT vehicle unit 102 can be positioned above a primary coil, wherein the primary coil is mounted, for example, on the floor of a garage. The primary coil is typically part of what is referred to as a WPT floor unit 111. The primary coil is connected to a power supply 110 (in this document also referred to as charging unit 110). The power supply 110 can be a radiofrequency generator which generates an AC (Alternating Current) in the primary coil of the WPT floor unit 111, as a result of which a magnetic field is induced. This magnetic field is also referred to as an electromagnetic charging field in this document. Given sufficient magnetic coupling between the primary coil of the WPT floor unit 111 and the secondary coil of the WPT vehicle unit 102 across the underbody ground clearance 120, the magnetic field induces a corresponding voltage and therefore also a current in the secondary coil. The induced current in the secondary coil of the WPT vehicle unit 102 is rectified by the rectifier 101 and stored in the storage unit 103 (for example in the battery). It is therefore possible to transmit electrical energy in a cable-free manner from the power supply 110 to the energy store 103 of the vehicle 100. The charging process can be controlled in the vehicle 100 by a charging controller 105 (also referred to as a WPT controller 105). To this end, the charging controller 105 can be designed to communicate, for example in a wireless manner, with the charging unit 110 (for example with a wall box) or with the WPT floor unit 111.

The electromagnetic charging field which is generated by the AC in the coils of the units 111, 102 can have a disturbing effect on the surrounding area. For example, the electromagnetic field can have an adverse effect on functions of the vehicle 100 or of adjacent vehicles 100. In particular, a keyless access function and/or a keyless engine start function of the vehicle 100 can be adversely affected by the electromagnetic field. The keyless access function and/or the keyless engine start function may be vehicle functions in which a vehicle key communicates with the vehicle 100 via a wireless communication connection in order to allow access to the vehicle 100 and/or in order to start the engine of the vehicle 100, without any action by the user of the vehicle key. The vehicle key can remain, for example, in a pocket of the user.

The present document is concerned with the technical object of providing vehicle functions, in particular a keyless access function and/or engine start function, in interaction with an inductive charging process of the vehicle without disturbance.

One aspect of the invention describes a control unit for a charging system for transmitting electrical energy to a vehicle in a wireless or cable-free manner. The charging system may be, for example, an inductive charging system. The vehicle can be, for example, a passenger car, a heavy goods vehicle and/or a motorcycle. The charging system can have one or more coils by which an electromagnetic charging field is generated. The charging field typically comprises frequency components in a predefined charging field frequency range. The charging field frequency range can lie in the LF (Low Frequency) range, for example at 80-90 kHz. Electrical energy can be transmitted to the vehicle by the electromagnetic charging field.

The vehicle, which draws electrical energy via the charging field, or an adjacent vehicle can provide a vehicle function, wherein the vehicle function comprises emitting a signal. The signal can be emitted by a transmitter unit of the vehicle or of the adjacent vehicle. The signal can include frequency components in a signal frequency range. The signal frequency range can lie in the LF range, for example at 20-140 kHz.

The control unit is designed to detect that the transmitter unit (for example of the vehicle or of the adjacent vehicle) is emitting or will emit a signal for providing the vehicle function. In this case, the signal is disturbed by the charging field, for example because the signal frequency range and the charging field frequency range overlap and/or adjoin one another and/or because a receiver of the signal (for example the first and/or second receiver unit described in this document) is disturbed by the charging field frequency range. Disturbance of the emitted signal by the charging field can lead to the provided vehicle function being adversely affected.

The control unit is therefore designed to cause the electromagnetic charging field to be interrupted if it has been detected that the transmitter unit is emitting or will emit the signal. In this way, it is possible to ensure that the vehicle function of the vehicle or of the adjacent vehicle is not disturbed by the inductive charging process.

The provided vehicle function may be a keyless access function to a vehicle and/or a keyless engine start function of an engine of the vehicle. In this case, the signal can include a request signal from the transmitter unit of the vehicle to a first receiver unit of a vehicle key for providing the access function and/or engine start function. Automatically switching off the charging field means it is possible for the receiver unit of the vehicle key to have less stringent requirements in respect of frequency selectivity and signal processing. Therefore, energy-efficient, space-efficient and cost-effective receiver units can be used for the vehicle key.

In order to detect emission of the signal by the transmitter unit, the charging system can include a second receiver unit which is designed to receive the signal which is sent by the transmitter unit. The second receiver unit can have a higher frequency selectivity than the first receiver unit. In particular, the second receiver unit can be designed to receive at least a portion of the signal which is sent by the transmitter unit, even when the charging field is present. The control unit can then be designed to ascertain whether the second receiver unit has received at least a portion of the signal, and therefore detect that the transmitter unit is emitting the signal. Therefore, it is possible to identify, in a reliable manner, that a vehicle function should be provided in the vehicle or in the adjacent vehicle.

The signal which is emitted by the transmitter unit can include a large number of signal portions which are sent sequentially one after the other. A first portion of the signal can then be designed to prepare a receiver unit of the signal to receive the remaining portions of the signal. The second receiver unit (that is to say the receiver unit of the charging system) can be designed to receive this first portion of the signal, and the control unit can be designed to detect that this first portion of the signal has been emitted. The charging field can then be interrupted. The interruption can be implemented in such a way that, when the further portions of the signal are emitted by the transmitter unit, the charging field is already interrupted and therefore no longer disturbs the transmission of the signal. In this way, it is possible to ensure that the vehicle function can be provided without the signal being used again. Therefore, the vehicle function can be provided without a time delay.

The control unit can be designed to receive a message which is sent via a bus of the vehicle. In this case, the message indicates that the transmitter unit of the vehicle is emitting or will emit the signal. In order to receive the message, the control unit can have access to the bus of the vehicle (for example to a CAN bus of the vehicle). The reliability of the detection of the signal being sent by the transmitter unit can be increased by taking account of messages on a bus of the vehicle. Furthermore, it may be possible to avoid costs of providing a second receiver unit for the charging system.

The message can include a message from a proximity sensor of a door of the vehicle relating to a recorded proximity (for example if the vehicle function is an access function). On the basis of the proximity message, it is possible to detect, even before the signal is emitted, that the signal should be emitted. Therefore, the charging field can be interrupted in advance before the signal is sent.

As an alternative or in addition, the message on the bus can include a message from a controller of an access function and/or an engine start function of the vehicle relating to the sending of a request signal.

The control unit can be designed to cause a floor unit of the charging system to interrupt the electromagnetic charging field. As an alternative or in addition, the control unit can be designed to cause a power supply to the floor unit and/or to a primary coil of the charging system to be interrupted. Owing to one of these measures, it is possible to ensure that the charging field can be briefly interrupted, that is to say interrupted for a short time delay.

A further aspect describes a vehicle (for example a passenger car, a heavy goods vehicle or a motorcycle). The vehicle has a secondary coil for receiving electrical energy by way of an electromagnetic charging field. Furthermore, the vehicle has a control unit, described in this document, which can cause the charging field to be interrupted in order to allow a vehicle function of the vehicle or of an adjacent vehicle to be provided without disturbance.

A further aspect describes a charging apparatus of a charging system for transmitting electrical energy to a vehicle by way of an electromagnetic charging field. The charging apparatus includes a charging unit for providing electrical energy, for example from a power supply system. Furthermore, the charging apparatus includes a floor unit (which comprises a primary coil) for generating the charging field. The charging apparatus also includes a control unit, described in this document, which can cause the charging field to be interrupted in order to allow a vehicle function of the vehicle which is to be charged or of an adjacent vehicle to be provided without disturbance.

A further aspect describes a method for providing a vehicle function in a vehicle or in an adjacent vehicle. The vehicle is designed to receive electrical energy by way of an electromagnetic charging field. The method detects that a transmitter unit of the vehicle or of the adjacent vehicle is emitting or will emit a signal relating to the vehicle function. In the process, the signal will be disturbed by the charging field. The method further interrupts the electromagnetic charging field if it has been detected that the transmitter unit is emitting or will emit the signal.

A further aspect describes a software (SW) program. The SW program can be designed in order to be executed on a processor (for example on a control unit or a controller), and in order to thereby execute the method described in this document.

A further aspect describes a storage medium. The storage medium can store an SW program which is designed in order to be executed on a processor, and in order to thereby execute the method described in this document.

It should be noted that the methods, apparatuses and systems described in this document can be used both alone and in combination with other methods, apparatuses and systems described in this document. Furthermore, any aspects of the methods, apparatuses and systems described in this document can be combined with one another in a variety of ways. In particular, the features of the claims can be combined with one another in a variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of an exemplary apparatus for inductively charging a vehicle.

FIG. 2a is a schematic diagram of an exemplary vehicle comprising a secondary coil and one or more transmitter units for communicating with a vehicle key.

FIG. 2b is a schematic diagram of an exemplary vehicle key.

FIG. 3 is an exemplary flow chart illustrating a method for providing a vehicle function, for example a keyless access function, for a vehicle.

### DETAILED DESCRIPTION OF THE DRAWINGS

As stated at the outset, the present document is concerned with providing vehicle functions in interaction with an inductive charging system. The invention will be described, by way of example, for the vehicle function “keyless access”. However, the invention can also be applied to other vehicle functions which are influenced and/or disturbed by the electromagnetic radiation which is generated during an inductive charging process.

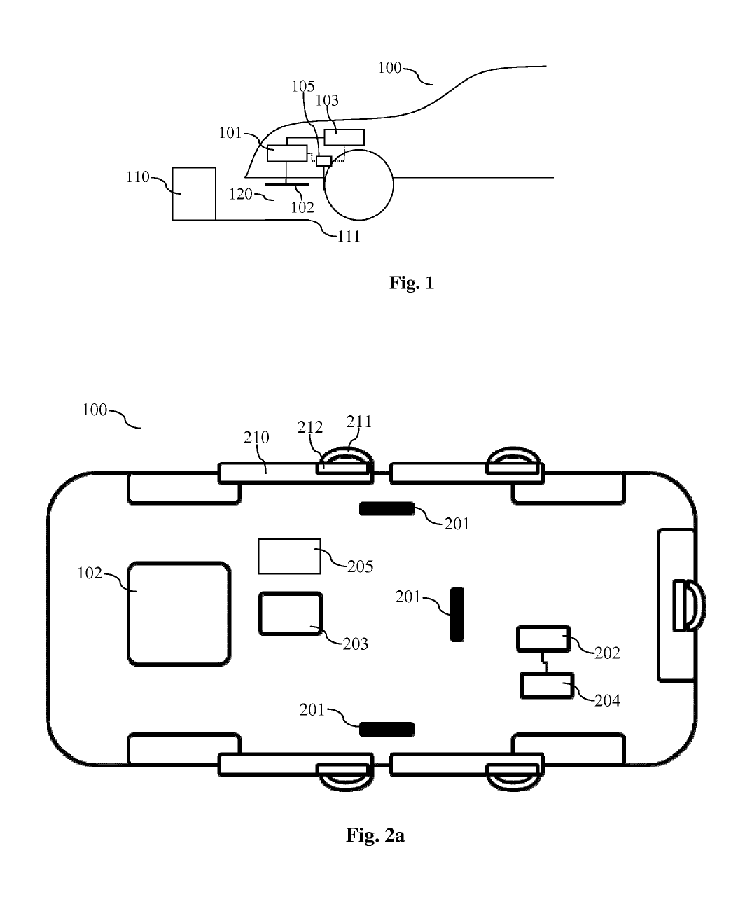

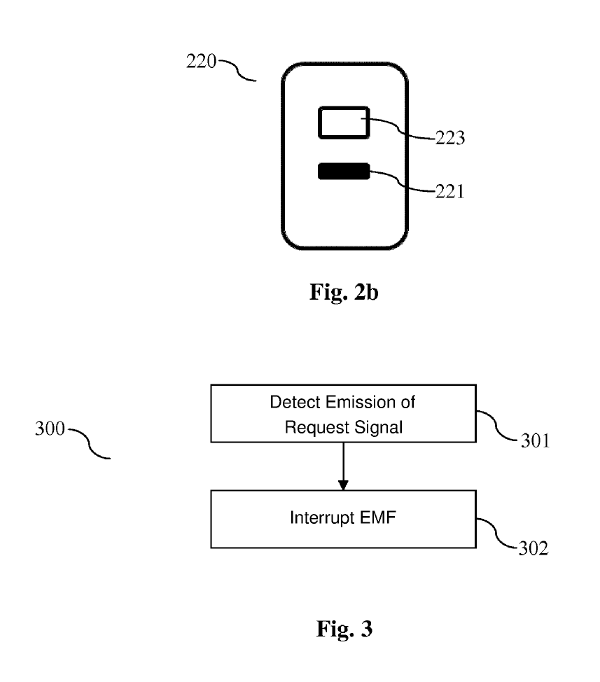

Various vehicle manufacturers provide a keyless access function (also referred to as a “smart key”) to a vehicle 100 (in the case of BMW by the name “comfort access” for example). The keyless access function permits a driver to open a vehicle door 210 or to start the engine of the vehicle 100 without using the key/lock principle (see FIG. 2a). In order to open the door 210, the driver grasps the door handle 211. A proximity sensor 212 on or in the vicinity of the door handle 211 senses, that is to say records, this movement. This is followed by a specific LF signal (LF: Low Frequency) being sent by one or more transmitter units 201 of the vehicle 100. In other words, the one or more transmitter units 201 can be designed to emit an electromagnetic field (in particular in the LF range). Exemplary transmission frequencies of the one or more transmitter units 201 lie in the range of 20-140 kHz (for example 20 kHz, 124 kHz, 125 kHz, 127 kHz, 133 kHz or 135 kHz).

The electromagnetic field which is emitted by the one or more transmitter units 201 can include a signal (also referred to as request signal). The emitted request signal can have a plurality of portions. A first portion of the request signal can be designed to wake up a receiver unit 223 in a key 220 of the driver, that is to say to prepare it to receive further information (see FIG. 2b). A further portion of the request signal can have information for identifying the vehicle 100. The various portions of the request signal which is emitted by the one or more transmitter units 201 can be transmitted with a time delay.

The receiver unit 223 in the key 220 is designed to receive the signals or signal portions which are transmitted by the one or more transmitter units 201, and to ascertain the signal strength of the signals or signal portions. A key transmitter unit 221 of the key 200 responds to the received request signal with a response signal. The response signal is typically transmitted in a different (typically higher) frequency range than the request signal. For example, the response signal can be transmitted with a response frequency of 433 MHz (that is to say in the HF (High Frequency) range).

The response signal can be composed of a plurality of portions. A first portion of the response signal can serve to identify the key 220 and a further portion of the response signal can be an indicator for the measured signal strength of the request signal. One or more receiver units 204 of the vehicle 100 can receive the response signal and/or the response signal portions and pass it/them on to a controller 202 of the vehicle 100. The controller 202 can be designed to check whether the key 220 matches the vehicle 100. Furthermore, the position of the key 220 relative to the vehicle 100 can be calculated by way of triangulation or by using a lookup table. If the estimated position of the key 220 matches the position of the proximity sensor 212 (for example the area surrounding the door 210 which is touched and/or the door handle 211 which is touched), the door 210 and/or the entire vehicle 100 will be opened.

The abovementioned procedure for comparing the relative identity/position of the vehicle 100 and key 220 typically takes up a time period of approximately 100 ms. That is to say, owing to the short time period, the abovementioned procedure typically remains unnoticed by the driver, with the result that the driver can open the door 210 directly by grasping the door handle 211. An analogous procedure for comparing identity also typically takes place when the engine is started.

As already explained, the vehicle 100 can be equipped for inductively charging a vehicle battery 103. This is illustrated by the WPT vehicle unit 102 in FIG. 2a. For the inductive charging operation, the current, the voltage and the frequency from a domestic installation can be converted into the operating range of the inductive charging system. This conversion can be implemented in one stage by an AC/AC converter or in two stages by an upstream AC/DC converter and a downstream DC/AC converter. The corresponding converters can be arranged in the charging unit 110 (for example in the inductive wall box) and/or in the WPT floor unit 111 (which comprises the primary coil). An electromagnetic charging field with a specific frequency is built up in the WPT floor unit 111. In this case, the frequency of the charging field typically lies between 80-90 kHz. In the WPT vehicle unit 102, a current is induced in the secondary coil by the charging field. The induced alternating current is rectified and filtered, with the result that an on-board electrical supply system of the vehicle 100 can be supplied with power and/or the vehicle battery 103 can be charged by way of the resulting direct current.

Therefore, the frequencies for the inductive charging (80-90 kHz) lie in an adjacent frequency range and/or in the same frequency range as the frequency range which is used for emitting a request signal relating to the keyless access function (20-140 kHz). In particular, the frequencies for the inductive charging lie in a frequency range which can disturb the reception of the request signal relating to the keyless access function. In order to keep the energy consumption of a key 220 low, the receiver unit 223 of a key 220 is typically relatively sensitive and relatively less frequency-selective. Therefore, disturbances can occur in the key 220 owing to the electromagnetic charging field of the inductive charging system. In particular, this can lead to the keyless access function no longer functioning or functioning only with restrictions, while the inductive charging system is active.

The inductive charging system is therefore designed in such a way that it can detect that a request signal should be emitted or has been emitted to a key 220 by the one or more transmitter units 210 of the vehicle 100. Furthermore, the charging system is designed to (at least temporarily) interrupt the inductive charging process if it has been identified that a request signal should be emitted or has been emitted. Owing to the interruption in the inductive charging process, it is possible to ensure that the request signal which is emitted by the one or more transmitter units 201 can be received by the receiver unit 223 of the key 220 without disturbances. Furthermore, disturbance-free provision of the keyless access function can be ensured as a result. After the request signal is transmitted to the key 220, the inductive charging process can then be reactivated. By way of example, the charging process can be resumed after the response signal is received by the receiver unit 204 of the vehicle 100.

The inductive charging system can include a receiver unit 203 which is designed to (at least partially) receive the request signal. Therefore, the inductive charging system can use the receiver unit 203 to detect whether a request signal has been emitted by the one or more transmitter units 201.

In other words, a receiver unit 203 can be connected to the inductive charging system. A receiver unit 203 of this kind is illustrated by way of example as part of the vehicle 100 in FIG. 2a. The receiver unit 203 can be designed to measure the frequency range of the request signal within a narrow band, that is to say with a relatively high frequency selectivity. In particular, the receiver unit 203 can be designed in such a way that the receiver unit 203 is not disturbed by the electromagnetic charging field of the coils of the units 102, 111. The use of a receiver unit 203 of this kind as part of the inductive charging system is possible since there are less stringent energy restrictions in the inductive charging system than for the receiver unit 223 of the key 220 and therefore more complex signal processing for isolating the request signal is possible. In addition, specific properties of the charging field (for example the frequency) are known in the charging system. These known properties can likewise be taken into account when isolating the request signal.

The inductive charging system (for example a control unit 205) can therefore use the signals which are recorded by the receiver unit 203 to detect that the vehicle in which it is located or an adjacent vehicle 100 is emitting a request signal. As soon as this is detected, the inductive charging system can be switched off if an active electromagnetic charging field is generated by the charging system. The control unit 205 is illustrated by way of example as part of the vehicle 100 in FIG. 2a. As an alternative or in addition, the control unit 205 can be part of the charging station 110 and/or of the WPT floor unit 111. Furthermore, the control unit 205 can also be provided as a unit which is separate from the vehicle 100 and from the charging station 110/floor unit 111.

The electromagnetic charging field can be switched off so rapidly that only a portion of the request signal is disturbed (for example only a portion of the request signal with which the receiver unit 223 in the key 220 is to be woken up). However, the receiver unit 223 of the key 220 can typically still receive the remaining portion of the request signal (in particular the portion which includes an identification of the vehicle 100) and therefore execute its functionality. The restriction as a result of the combination of a keyless access function and the inductive charging can therefore be minimized or eliminated. In particular, the time period for the procedure for exchanging the request signal and the response signal is not extended.

As an alternative or in addition, the request signal can be repeatedly sent from the one or more transmitter units 201, for example if it is identified that no response to the request signal is received within a predefined time period (of, for example, a few ms). The electromagnetic charging field can be switched off within the predefined time period, so that there are no longer any disturbances by the electromagnetic charging field when the request signal is repeatedly sent. Therefore, the receiver unit 223 of the key 220 can receive the repetition of the request signal without disturbance, and therefore execute its functionality.

The receiver unit 203 can be installed in the charging unit 110 (for example in the inductive wall box), in the WPT floor unit 111, in the WPT vehicle unit 102, in the WPT controller 105 and/or can be installed separately. Installation in the WPT floor unit 111 is advantageous since the electromagnetic field for the inductive charging is built up in the WPT floor unit 111 and therefore, after detection of a request signal, a rapid response can be made, that is to say rapid switch-off can be performed. In addition, the WPT floor unit 111 can have an LF receiver unit, which can possibly be used for recording a request signal, for the purpose of positioning the secondary coil above the primary coil. As a result, the costs for providing the receiver unit 203 for the request signal can be reduced.

The rapid switch-off device for the inductive charging process can be installed either in the charging unit 110 (for example in the inductive wall box) or in the WPT floor unit 111. Interruption of driving of the converters (AC/AC or AC/DC, DC/AC) or opening of the electrical circuit is advantageous for rapid switch-off of the charging process.

As an alternative or in addition, other indicators for emitting a request signal can be used. For example, signals on a bus (for example on a CAN (Controller Area Network) bus) of the vehicle 100 can be evaluated. Recording that the proximity sensor 212 on a door handle 211 of the vehicle 100 is being approached is typically transmitted via a bus of the vehicle 100. A control unit 205 of the inductive charging system can be designed to receive the “approach” signal and then cause the inductive charging system to be switched off.

As an alternative or in addition, the control unit 205 of the inductive charging system can be designed to receive a message, which has been exchanged via a data bus, that a request signal has been sent by the one or more transmitter units 201 of the vehicle 100, and then to cause the inductive charging system to be switched off

FIG. 3 shows a flowchart of an exemplary method 300 for providing a vehicle function of a vehicle 100, in particular an access function and/or engine start function. Providing the vehicle function includes emitting a request signal. The vehicle 100 is designed to receive electrical energy by means of an electromagnetic charging field. In the process, the request signal is disturbed by the charging field, for example because the request signal and the charging field comprise frequency components in a common and/or an adjacent frequency range.

The method 300 detects 301 that a transmitter unit 201 of the vehicle 100 or of an adjacent vehicle 100 is emitting or will emit a request signal relating to the vehicle function. Furthermore, the method 300 interrupts 302 the electromagnetic charging field if it has been detected that the transmitter unit 201 is emitting or will emit the signal. After a predefined time interval and/or after the vehicle function has been carried out, the charging field can be built up again in order to continue with the inductive charging process.

In summary, it can be stated that the measures described in this document allow a keyless access function and/or engine start function of a vehicle 100 to be provided in combination with an inductive charging system. In the process, the inductive charging system can be used for charging the vehicle in which the access function and/or engine start function are also provided, and/or for charging an adjacent vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control unit for a charging system for transmitting electrical energy to a vehicle, wherein the charging system comprises one or more coils by which an electromagnetic charging field is generated; the control unit comprising:
a controller that includes a processor and executes:
a detection of a transmitter unit that is emitting or will emit a signal which is disturbed by the charging field; and
an interruption of the electromagnetic charging field if it has been detected that the transmitter unit is emitting or will emit the signal.

2. The control unit as claimed in claim 1, wherein the signal comprises a request signal from the transmitter unit to a first receiver unit of a vehicle key for providing an access function and/or engine start function of the vehicle or of an adjacent vehicle.

3. The control unit as claimed in claim 2, wherein:
the charging system comprises a second receiver unit which is configured to receive the signal which is sent by the transmitter unit; and
the control unit further executes a determination of whether the second receiver unit has received at least a portion of the signal.

4. The control unit as claimed in claim 1, wherein the control unit further executes a reception of a message which is sent via a bus of the vehicle; wherein the message indicates that the transmitter unit is emitting or will emit the signal.

5. The control unit as claimed in claim 4, wherein the message comprises:
a message from a proximity sensor of a door of the vehicle relating to a recorded proximity; and/or
a message from a controller of an access function and/or engine start function of the vehicle relating to the sending of a request signal.

6. The control unit as claimed in claim 1, wherein the control unit further executes causing a floor unit of the charging system to interrupt the electromagnetic charging field.

7. The control unit as claimed in claim 1, wherein the control unit further executes causing a power supply to a floor unit of the charging system to be interrupted.

8. A vehicle, comprising:
a control unit for a charging system according to claim 1; and
a secondary coil that receives electrical energy via the electromagnetic charging field.

9. The vehicle according to claim 8, wherein the signal comprises a request signal from the transmitter unit to a first receiver unit of a vehicle key for providing an access function and/or engine start function of the vehicle or of an adjacent vehicle.

10. The vehicle according to claim 8, wherein the control unit further executes a reception of a message which is sent via a bus of the vehicle; wherein the message indicates that the transmitter unit is emitting or will emit the signal.

11. The vehicle according to claim 8, wherein the message comprises:
a message from a proximity sensor of a door of the vehicle relating to a recorded proximity; and/or
a message from a controller of an access function and/or engine start function of the vehicle relating to the sending of a request signal.

12. The vehicle according to claim 8, wherein the control unit further executes causing a floor unit of the charging system to interrupt the electromagnetic charging field.

13. The vehicle according to claim 8, wherein the control unit further executes causing a power supply to a floor unit of the charging system to be interrupted.

14. A charging apparatus of a charging system for transmitting electrical energy to a vehicle via an electromagnetic charging field, the charging apparatus comprising:
a charging unit that provides electrical energy from a power supply system;
a floor unit coupled with the charging unit, the floor unit generating the electromagnetic charging field; and
a control unit for the charging system, the control unit comprising:
a controller that includes a processor and executes:
a detection of a transmitter unit that is emitting or will emit a signal which is disturbed by the charging field; and
an interruption of the electromagnetic charging field if it has been detected that the transmitter unit is emitting or will emit the signal.

15. A method for providing a vehicle function in a vehicle or in an adjacent vehicle, wherein the vehicle is configured to receive electrical energy via an electromagnetic charging field, the method comprising the act of:
detecting that a transmitter unit of the vehicle or of the adjacent vehicle is emitting or will emit a signal relating to the vehicle function, wherein the signal is disturbable by the electromagnetic charging field; and
interrupting the electromagnetic charging field upon detecting that the transmitter unit is emitting or will emit the signal disturbable by the electromagnetic charging field.
